(19) United States
(12) Patent Application Publication
(10) Pub. No.: US 2009/0310464 A1
(43) Pub. Date: Dec. 17, 2009

(54) THREE-DIMENSIONAL OPTICAL INFORMATION CARRIER

(75) Inventors: Ortal Alpert, Jerusalem (IL); Yair Salomon, Jerusalem (IL)

Correspondence Address: OLIFF & BERRIDGE, PLC, P.O. BOX 320850, ALEXANDRIA, VA, 22320-4850, US

(73) Assignee: MEMPILE INC., Wilmington, DE (US)

(21) Appl. No.: 12/519,836

(22) PCT Filed: Dec. 18, 2007
(86) PCT No.: PCT/IL2007/001564

§ 371 Date: Jun. 18, 2009

Related U.S. Application Data
(60) Provisional application No. 60/875,400, filed on Dec. 18, 2006.
(60) Provisional application No. 60/940,968, filed on May 30, 2007.

(51) Int. Cl. G11B 7/24; G11B 7/007

(52) U.S. Cl. 369/112.01; 369/275.1; G9B/7.139; G9B/7.03

(57) ABSTRACT

An optical data carrier is presented comprising first and second recordable media located in at least one first portion and at least one second portion of the data carrier, respectively. These first and second recordable media differ from each other in a storage capacity and a data recording rate.

### FIELD OF THE INVENTION

This invention is generally in the field of optical information carriers, and relates to an optical information carrier utilizing non-linear media, in which data is recorded/read by multi-photon interaction.

### BACKGROUND OF THE INVENTION

Storage of data on optical media such as Compact Discs (CD) or Digital Versatile Discs or Digital Video Discs (DVD) is one of the most popular data storage techniques in the industry Earlier developed optical discs such as CDs are gradually replaced by DVDs; and Blue DVD (DVD players based on “blue laser” or “blu ray” technology) is expected soon to replace the conventional DVDs. A need in larger storage volumes dictated the change of storage technologies. The storage capacity of CD is slightly above 600 MB, DVD has a storage capacity of about 5 GB and Blue DVD may be more than 25 GB. Despite these developments, there is already a need for devices capable of providing a higher storage capacity.

The transition path from CD to DVD and Blue DVD has developed such that certain compatibility between formats, reading protocols, etc., was maintained preserving user investment. This smooth transition from one technology to the other facilitated rapid technology acceptance and commercial success.

Another type of optical data carriers have recently been developed (WO07007319, WO06075327, WO06075329, WO0173779 (U.S. Pat. No. 7,011,925), WO06075328, WO03070689, all assigned to the assignee of the present application), which utilize non-linear optical media, in which data recording and/or reading is based on multi-photon interaction, and which is capable of storing terabytes of data.

### GENERAL DESCRIPTION

There is a need in the art in a novel optical information carrier capable of storing large amount of data, which can be easily recorded and retrieved.

As indicated above, the conventionally used optical data carriers are DVDs and Blue DVDs, which are “reflective discs”. The recently developed data carriers utilize a non-linear recording medium in which at least one of data recording and reading processes is based on multi-photon interaction, and are higher capacity data carries as compared to the conventionally used ones. In such data carriers utilizing non-linear media recording/reading beam(s) is/are of wavelength(s) different from that of a read signal (being a response of the recording medium to the reading beam). Non-linear optical data carriers, e.g. carriers made of polymer-based photochromic medium, characterized by multi-photon absorption, provide enormous storage volume that may exceed terabyte. Various examples of such type of recordable media are described in the following publications WO07007319, WO06075327, WO06075329, WO0173779, WO06075328, WO03070689, all assigned to the assignee of the present application.

The above two types of optical information carriers, are different in the principles of data recording/reading and accordingly need different types of pick up devices (drives). Also, the non-linear optical data carriers might need longer data recording time as compared to the Blue-DVDs, while providing fast data reading similar to that of the reflective-media Blue-DVDs.

It is thus desirable to provide an optical data carrier having an increased storage capacity, as compared to the conventional devices, and which can be recorded/read by the existing DVD standards.

Also, as indicated above, a non-linear recordable medium provides enormous storage volume that may exceed terabyte. However, reading of information recorded in a non-linear medium by a read-out laser spot in some cases might cause to certain extent an effect of recording or what is called graying. In the context of the present disclosure the term “graying” signifies a process in course of which the reading event causes some undesired recording. The effect of graying may thus be caused by multiple reading of the same recorded data. In this connection, the following should be understood: Generally, any type of rewritable optical data carrier has an area of the recordable media for recording the actual user data or files where user produced files are recorded, and has a so-called file system or root area. The system or root area is a section of a recordable media in which basic information for managing the recording of the user data files upon recording and upon reading is stored. This information may include that of location of the files or sections (blocks) of the files if the file data recorded in the user data area may be physically broken up into sections. Reading and interpretation of the system files helps in replaying the user files in logical continuity and in recording new files. User files are accessed only when a user needs to select a particular file from a plurality of recorded user files. Access to any user file is always accompanied by reading relevant data from the system files. Naturally, a system data file is accessed more frequently than user data files. System data files may be changed each time when user data is accessed, extracted, altered or deleted.

According to one broad aspect of the invention, there is provided an optical data carrier which comprises a non-linear recordable media and which is configured for recording at least two different data patterns differing from one another in a recording rate and reliability.

According to some embodiments of the invention, the recording of at least two different data patterns is enabled by providing in said optical data carrier a second recordable media, which is reflective-type media, such as used in the conventional optical discs.

Thus, according to another aspect of the invention, there is provided a hybrid optical data carrier comprising first and second recordable media located in at least one first and at least one second portion of the data carrier, respectively, said first and second recordable media differing from each other in a storage capacity and a data recording rate.

The first and second recordable media differ from each other in at least one of the following: the characteristics of recording response; the characteristics of the recording process (e.g. use of linear or non-linear absorption and the spectral characteristics thereof); the characteristics of the linear or non-linear susceptibilities/sensitivities/cross-sections; and the dynamics of the process (e.g. time constants). Consequently these differences lead inter alia to differences in the optical radiation required for data recording, including an optical radiation power and/or a spectrum of optical radiation required for creation of a pattern formed by spaced-apart recording regions in the media.

The first recordable media is the higher data recoding rate and lower data storage capacity media, than the second recordable media. In some embodiments of the invention, the first recordable media is configured as a Blue DVD or HD-DVD media, and the second recordable media is a non-linear optical media having a fluorescent property varying on the occurrence of multi-photon interaction.

The first recordable media serves as a rewritable media, while the second recordable media may serve as a WORM type media. The first recordable media, which is characterized by higher recording rate (typically with lower power of optical radiation) and lower storage capacity than the second recordable media, may serve as a temporary memory; at least some of the files recorded in the first recordable media can then be transferred therefrom into the second recordable media. This allows a user for manage the rewritability of data in the high recording rate and low storage capacity memory and manage the data transfer from this high recording rate low storage capacity memory to the high storage capacity one, while both types of memory provide for fast data retrieval.

As indicated above, recording/reading in a non-linear optical medium might suffer from an effect of graying, which effect practically does not exist in the reflective-type Blue DVD or HD-DVD. Accessed more frequently the file system area, when being located in a non-linear medium, is more likely to have a higher level of graying than user data area. Thus, system area may rapidly become not operable if proper recording and reading operations are not installed. Ideally, different physical processes, dynamics and thresholds are used for data recording and data reading so as to prevent destructive graying during the read process. WO 07/007,319 to the same assignee discloses a method of optimal recording and reading information in a non-linear optical medium. In practical situations, even small amount of graying might become substantial when the same data block is read a large number of times.

This “graying” problem can thus be solved in the hybrid data carrier of the present invention by transferring a file allocation table from the non-linear media into the Blue DVD or HD-DVD type media. Self-operating system files are stored on the most appropriate media, which is DVD or HD-DVD media in the present example. The non-linear optical storage media provides for higher data protection than the DVD or HD-DVD one.

Thus, the hybrid data carrier of the present invention may utilize a common files system, allowing files management (user management is possible), as well as a common drive system for controlling the distribution of files in the two different recordable media portions (i.e. where a specific file is to be recorded and whether the file is to be then transferred to the other media). Although the data recording/reading in such a hybrid data carrier typically requires two separate optical units, a common data coding system can be used. To provide compatibility to conventional media interfaces, this common file system may be deployed as an additional data organization level on top of that of the conventional media file system.

The first and second recordable media may be adhesively bonded to each other via an adhesive layer. The latter may be a retro-reflective layer thus preventing the optical radiation, used for recording/reading in one of the first and second media, from propagation into the other media. In some embodiments of the invention, the first and second data carrier portions are spaced from each other by a reinforcing symmetric carcass which is optically transparent and has higher strength than the second media, which is of the type in which recording and/or reading is/are based on multi-photon interaction.

According to some other embodiments of the invention, it provides a solution for eliminating or at least significantly reducing the effect of graying that might happen in the non-linear recordable media by using more than one type of recording in the non-linear media: at least a first type of recording is used for recording main data (user files) and at least a second type having higher reliability is used for recording system data. Such an optical data carrier includes a non-linear recordable media (and may or may not additionally include a reflective type recordable media), comprising groups of marks of different modulation depths corresponding to respectively system data and user data, the system data related marks having higher modulation depth than the user data related marks. In addition or alternatively, the data carrier comprises the reflective type media in which system data may be recorded.

System or root data recorded to higher reliability may have different characterizations such as higher modulation depth, different mark density or different encoding and error protection. System data may also be required to be efficiently access (e.g. in terms of access time) therefore it may be desirable to have system data recorded in separate regions so that it will be more easily recorded and accessed without significant sacrifice (e.g. of outer disk regions that allow for high data rate). The system data and user data related marks may be recorded in respectively central and peripheral portions of the disk-like non-linear recordable media.

Data that is known as being or expected to be frequently accessed data may be identified by the system as such and be recorded to higher reliability. Root file located at designated positions may indicate dynamic allocation of areas for recording such file with their special characteristics (e.g. mark modulation depth or track distances), thus providing for a file reliability hierarchy.

According to yet another aspect of the invention, there is provided a method for use in data recording on the above-described hybrid optical data carrier. The method comprises: recording data in the first recordable media with a relatively high recording rate; and transferring at least a part of said data recorded in the first recordable media to the second recordable media.

According to yet another aspect of the invention, there is provided a method for use in data recording on the hybrid optical data carrier comprising separately recording first and second data blocks in the first and second recordable media, respectively, with relatively high and low data recording rates; and transferring at least a part of said first data block from the first recordable media into the second recordable media.

According to yet further aspect of the invention, there is provided a drive system for use in recording/reading data in the hybrid optical data carrier. The system comprises: a first optical unit adapted for recording and reading data in the first recordable media; a second optical unit adapted for recording and reading data in the second recordable media; and a control unit including a first control utility adapted for analyzing and distributing data to be recorded between the first and second recordable media portions, and a second control utility adapted for transferring recorded data between the first and second recordable media portions.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic illustration of an optical data carrier according to an embodiment of the invention;

FIG. 2 is a schematic illustration of an optical data carrier according to another embodiment of the invention;

FIG. 3 shows an optical data carrier according to yet another embodiment of the invention;

FIG. 4 shows an optical data carrier according to yet further embodiment of the present invention configured to avoid effects of thermal stress and deformation;

FIG. 5 is a schematic illustration of a disc drive for reading and recording in the data carrier according to the present invention;

FIG. 6 exemplifies a method for recording/reading data in a hybrid data carrier according to the present invention;

FIGS. 7A and 7B illustrate an optical data carrier according to another embodiment of the invention (FIG. 7A) and read-out signals from such data carrier (FIG. 7B);

FIG. 8 illustrates an optical data carrier according to yet another embodiment of the invention; and

FIG. 9 shows yet further embodiment of the invention.

### DETAILED DESCRIPTION OF EMBODIMENTS

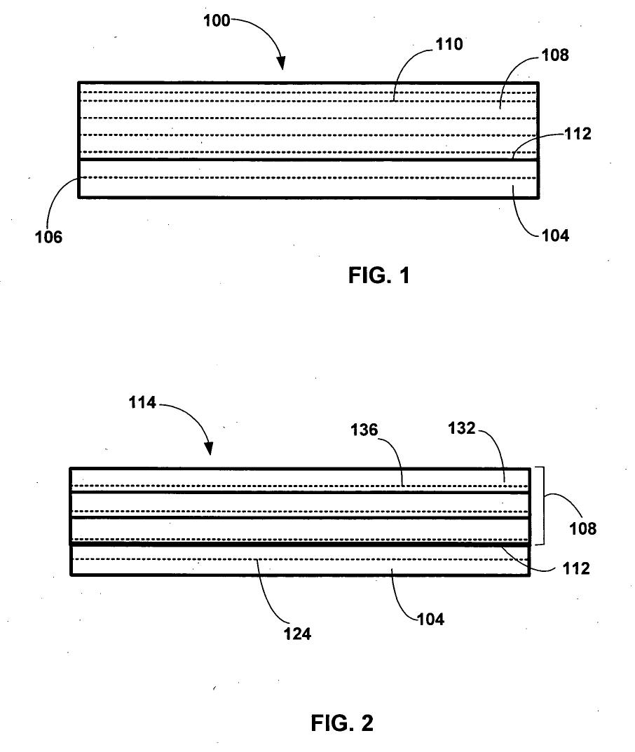

Referring to FIG. 1 there is schematically illustrated an optical data carrier, generally designated 100, according to an embodiment of the invention. The data carrier 100 is configured as the so-called “hybrid data carrier” or “hybrid optical disc, and includes a first recordable media 104 typically characterized by a reflective layer structure and by substrate thickness, and a second recordable media 108. The two media are adhesively bonded to each other via an adhesive layer 112.

The recordable media 104 and 108 are different and are both used for data recording/reading: The recordable media 108 is a three-dimensional non-linear optical media, such as one disclosed in the above-indicated publications (e.g. U.S. Pat. No. 7,011,925) to the same assignee as the present application, and presents a high data capacity part of the data carrier 100. The other recordable media 104 presents a complementing part of the hybrid data carrier, which is superior to the high data capacity part 108 in at least one of the following properties: data rewritability, reduced graying, higher recording rate. The complementing part 104 may include a Blu-ray compatible layer or HD-DVD compatible layer (the so-called optical complementing part), or a flash memory (‘chip’) which may also hold some processing capabilities (e.g. on the cartridge), or both a HD-DVD compatible layer and a chip. If the chip is used, the data carrier 100, in addition to data storage capabilities, may have some processing capabilities, including for example data protection capabilities and interfacing a computer system or other electronic devices, e.g. according to industry standards for peripheral devices or emulation of such interfaces, thereby allowing the hybrid data carrier 100 to be an accepted peripheral. For example, in some cases existing flash memory devices emulate recordable CD and in other cases emulate the ATA hard disk interface.

It should be noted that although in the present example the first and second media 104 and 108 of different optical properties are located in first and second disc portions, respectively, located one on top of the other, the present invention is not limited to this specific configuration. Generally, either one of the first and second media or both of them may be located in two or more spaced-apart disc portions. For example, the disc may include a first, non-linear media portion enclosed between two second, reflective media portions.

The HD-DVD or Blue DVD recordable media 104 may be a single-layer or a multi-layer media. This media may be of a recordable type. Data is written in the recordable media 104 on a well defined recording layer 106. The second recordable media 108 is formed by media of one or more monolithic bodies (plates). In each of the monolithic plates, data can be recorded in the form of a three-dimensional pattern of spaced-apart recorded regions arranged in multiple virtual layers 110. Each such virtual layer 110 may be capable of storing up to 5 GB of data. A distance between the virtual layers may be of about 3-15 microns. Depending inter alia on the required storage capacity of the data carrier, a thickness of the second disc portion 108 may vary from about a few hundreds of microns (e.g. 300 microns) up to a few millimeters (e.g. about 6 mm). Preferably, this recordable media 108 has an embossed or printed formatting layer.

It should be understood that any known configurations of the recordable media 104 and 108 can be used: recordable media being 104 being of the conventional configuration, and the recordable media 108 being of any suitable configuration disclosed in the above-indicated publications assigned to the same assignee as the present application, which are therefore incorporated herein by reference.

Reference is made to FIG. 2 showing schematically a hybrid optical data carrier 114 according to another embodiment of the invention. To facilitate understanding, the same reference numbers are used for identifying components that are common in all the examples of the invention. The data carrier 114 includes first and second recordable media 104 and 108 adhesively bonded to each other via an adhesive layer 112. The media 104 includes a conventional reflective type storage medium, such as a Blue DVD disc or a HD-DVD disc, and the media 108 includes a non-linear optical storage medium, such as photochromic medium. As shown in this example, the non-linear media portion 108 is configured as an assembly of plates 132 each made of the same monolithic body. Each plate or disc 132 has one (or more) embossed or printed formatted layer 136 that may serve as a reference for additional optically recorded formatted layer(s).

It should be noted that the bonded hybrid data carrier (such as the above described data carriers 100 or 114) may be subject to thermal stress and deformations. This is associated with the fact that the material of the disc portion 108 (typically polymer) and the material of which the conventional DVD/HD-DVD/CD are made have different coefficients of thermal expansion. Furthermore, recording and reading of information in/from the recordable media 108 requires significant laser power, typically in the red or infrared part of the spectrum. A portion of this energy is dissipated and absorbed in the body of disc portion 108 as heat. Red and IR radiation are transmitted through the disc portion 108 and reach disc portion 104. This penetrated radiation might be absorbed by disc portion 104 further increasing the amount of heat absorbed. Blue and HD-DVD discs are sensitive to heat, which might destroy their recording layers.

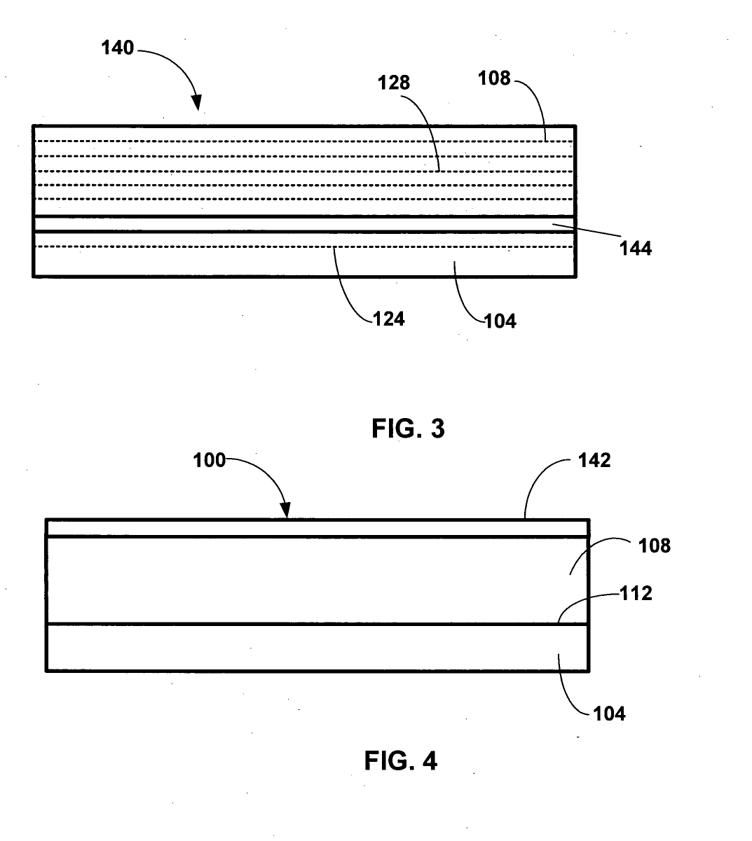

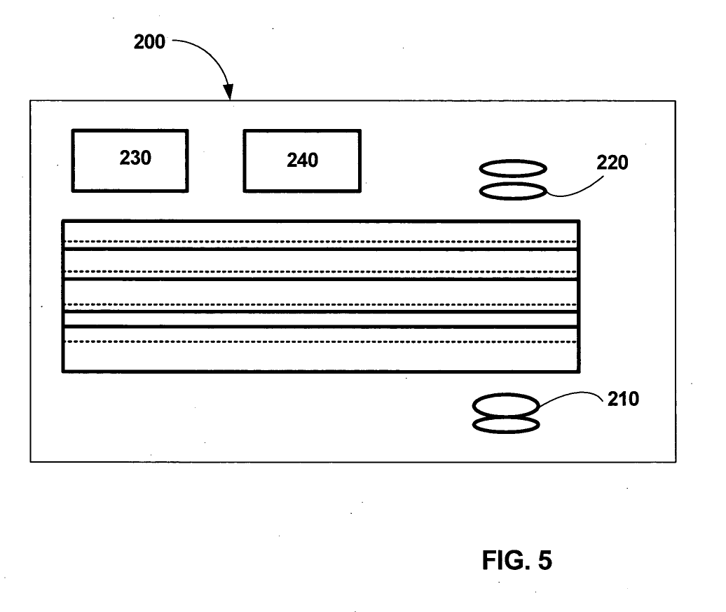

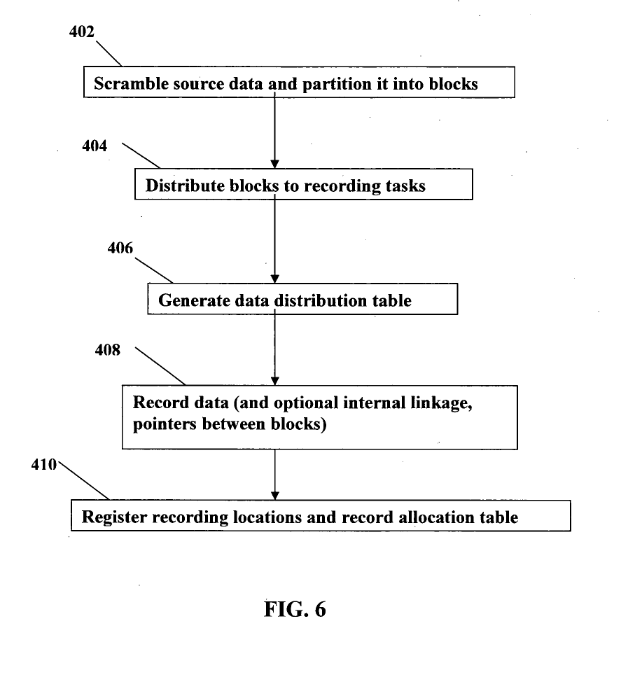

FIG. 3 exemplifies a hybrid data carrier according to yet another example of the present invention. Here, a data carrier 140, including the above-described recordable media portions 104 and 108, also has a retro-reflective layer 144. The latter may be deposited on the surface of the portion 108 such that it interspaces between the first and second portions 104 and 108. The retro-reflective layer 144 prevents laser power penetration into the portion 104 during recording/reading processes in the portion 108 (which processes typically require high laser power). Also, the use of the retro-reflective layer 144 improves collection of a luminescent signal generated during the data reading from the portion 108, since at least a part of the earlier wasted read signal is reflected back towards the read signal detector and may be now utilized. The principles of data recording/reading in/from the hybrid data carrier of the present invention will be described more specifically further below with reference to FIGS. 5 and 6.

FIG. 4 exemplifies how the remaining thermal stress and deformation may be avoided. To this end, a data carrier, configured generally similar to the above-described data carrier 100, additionally includes a portion 142 adhered to the outer surface of the portion 108. This disc portion 142 is made of optically transparent material(s) having higher strength than polymer materials(s) used in the recordable media 108, for example the disc portion 142 may be made of the same material(s) and thickness(es) as the recordable media 104. The disc portions 104 and 142 thus serve as a symmetric carcass that enhances the strength of the data carrier 100, and enables rotation of the data carrier 100 at a speed substantially higher than that of a similar data carrier having no such reinforcing carcass. Disc portions 104 and 142 do not necessarily need to have the same thickness, but it is preferable that they will have the same reinforcing characteristics. Examples of the data carriers of the disc 108 type utilizing such a symmetric reinforcing carcass are described in the above-indicated publications WO06111972, WO06111973 to the same assignee, which publications are incorporated herein by reference.

Reference is now made to FIG. 5 schematically illustrating an example of a disc drive system, generally designated 200, for recording/reading data in the hybrid data carrier 100 of the present invention. The drive system 200 has two optical units 210 and 220 accommodated at opposite sides of the data carrier and being associated with, respectively, the recordable media 104 and 108 configured as described above. Hence, the first optical unit 210 is configured for focusing radiation suitable for recording/reading in the recordable media type 104, for example, blue laser radiation for recording/reading the blue-disc portion 104. The second optical unit 220 is configured for focusing suitable radiation (red or infrared laser radiation) of the type capable of providing multi-photon interaction (e.g. two-photon interaction) with the recordable media 108 for recording/reading data therein. Examples of the data recording/reading schemes for the recordable media 108 and of securing the data therein are described for example in WO07007319, WO06111972, WO06111973, WO05015552, WO04032134, WO03077240 and WO07116401, all assigned to the assignee of the present application. The drive system 200 also includes a control unit including a first control utility 230 adapted for analyzing and distributing data to be recorded between the first and second recordable media 104 and 108, and a second control utility 240 adapted for transferring recorded data from the first to second media and vice versa.

The operation of the drive system 200 for recording/reading data in a hybrid data carrier, such as the above-described data carriers 100 and 114 will now be described, Blue and HD-DVD discs are characterized by exceptionally high data recording speeds, practically not limited by disc sensitivity, and their capacity may exceed 50 GB. Such capacity supports storage of a number of films and TV programs and the recording speed supports uninterrupted on-line recording of TV transmission programs. Thus, for high data rate on-line recording, where the data rate required is exceeding the data rate supported by photochromic recordable media 108, the control utility 230 operates to direct the data to be recorded to the first recordable media portion 104 of the hybrid data carrier. The capacity of media 104 is sufficient for uninterrupted and continuous recording of many hours of regular TV translations or a large number of artistic films. Upon completion of the data recording, the control utility 240 can operate to transfer the recorded data from the first media 104 to the second media 108 of the hybrid data carrier.

Thus, for all practical purposes, the Blue or HD-DVD media portion 104 serves as a buffer or short time data storage, and the photochromic media portion 108 serves as a long term higher capacity data storage facility. This is generally similar to the relation existing between a RAM/cache memory and hard drive existing in each computer.

The data recording and reading tasks may be performed securely by the use of a secure data archiving system as described in WO07116401 with some modifications as described below.

The data recording tasks may be performed in parallel when there is more than one optical unit, e.g. when the reflective-reading media type 104 is recorded using blue light, and the 3D non-linear media 108 is recorded using red light. It is also possible that more than one optical unit is used for recording/reading in each of the media portions 104 and 108.

Different optical units might be required to record data with different recording rates, for example because of recording at different resolutions or at different radii. The control utilities 230 and 240 are appropriately configured to take into account these different recording parameters.

FIG. 6 exemplifies the data recording procedure with the hybrid data carrier according to the invention. As shown, the source data is scrambled and partitioned (step 402) into recording blocks that are distributed for recording purposes to the different recording optical units, for example, by organizing the separated data into separate buffers (step 404), and data distribution table (or a similar data organization) is generated (step 406). Then, the data (and optional internal linkage, pointers between the blocks) is recorded (step 408). Recording locations are registered, and allocation is recorded (step 410). The scrambling of the source data, the data block distribution and the registration of the allocations can be performed using an encryption key disclosed in WO07116401.

Simultaneous recording on the two optical recordable media 104 and 108 of the hybrid data carrier is coupled by the data carrier rotation rate. If data in both recordable media are being recorded on the same radius, the ratio between the possible data rates is the ratio between the data resolutions (channel bits per mm) multiplied by a redundancy factor (user bits per recorded bits) of the respective encodings. The slower rate recording may be performed on tracks with lower linear speed (inner tracks), while the faster rate recording may be performed at the same time on the tracks with higher linear speed (outer tracks). This may increase the factor by more than 2, if conventional disc diameters (120 mm diameter) are used (inner radius is typically about 22 mm and outer radius is typically about 58 mm). Generally, the recording rate is the sum of all simultaneous recording rates and is higher than the recording rate of the high capacity part 108. The data protection and distributing may utilize a technique disclosed in WO07116401.

Thus, the present invention provides a novel hybrid optical data carrier, including two different recordable media portions, which allows data transfer in between those portions of the data carrier. The use of the recordable media portion based on a multi-photon excitable media in the data carrier allows for significantly increasing the amount of data storable in the data carrier. The use of the reflective type media portion allows for high-rate low-power data recording. The ability of data transfer in between the multi-photon excitable and reflective media provides for a very high capacity, easily recordable and readable data carrier.

The hybrid optical data carrier having, on the one hand, a recordable DVD/HD-DVD like media portion, and, on the other hand, ability to record huge volumes of information, is very useful since it allows recoding of long term storage data at a high data rate. It also combines the conventional reflective type storage technologies with the new and emerging storage technology.

It should be noted that the above-described hybrid data carrier, i.e. data carrier comprising non-linear type recordable media and the conventional recordable media (reflective type media), can be configured to enable the use of for data recording/reading conventional drives with at least partial compatibility (e.g. by adhering in the reflective medium part to a standard and/or by maintaining this standard's physical dimensions) and thus providing for a smoother transition between consecutive optical storage generations. To this end, the system files of the hybrid data carrier may be provided as an additional data organization level on top of the conventional media file system, e.g. by recording the system files of the hybrid data carrier in the conventional media main data sections.

As indicated above, a non-linear media might suffer from graying caused by multiple reading of the recorded data from the media. The present invention provides for improving the data reading reliability from such photochromic media by recording the system data in a different way than the user files data. According to this technique, data to be recorded may be categorized into types were each type is recorded at media or at different modulation depths (reading signal modulation depth) and with different error correction schemes. Each recording process provides different reliability control ways. The error correction parameters and properties (reliabilities, redundancies and error correction character) and the modulation depth used in different data blocks are set according to prior categorization of data retrieval requirements such as; expected number of required retrievals, required data reliability and data recording and retrieval rates. In a hybrid data carrier few types of data recordings and data reliabilities may be used; data recording may be performed to standard data and critical data reliability in either the first reflective data storage medium or the second 3D recordable storage medium.

The reliability of critical data, such as system data, can be enhanced in various ways resulting in a more reliable data encoding decoding processes. The principle approach is one that could enable maintaining high modulation depth of the read-out signal during the life of the data carrier. This may be achieved in a number of ways. In one embodiment the recording modulation depth of the system or more important and critical data is higher than the modulation depth of user files or rarely accessed data. This may however, result in slower, but still acceptable recording rate of the typically small critical files.

In another embodiment, the recording and retrieving also comprise more reliable forward error correction (FEC) encoding of the more important or critical data. For example, the FEC coding with higher redundancy and higher error resistance and stronger error detection capabilities is applied to reading the system data. A reason for this is that data reliability degrades nonlinearly with the decrease in SNR, and under certain thresholds the decoding error rate becomes so high that data blocks become unreadable. Thus it is preferable foremost to increase the quality of each recorded block. It is admitted that having more than one encoding scheme increases the system complexity, but in view of current available computing resources in the optical drive the benefit outweighs the complexity cost. This may be further enhanced by repeated reading of critical data, especially in cases where errors where not detected by the FEC parity checks.

In an additional embodiment, use of slower data retrieval (e.g. higher sampling rate with a slower disk rotation) is utilized for better detection of the actual information.

In a further embodiment, the recording of critical system information is performed on additional auxiliary positions within the data carrier or even on an additional auxiliary memory. Such system is implemented for example by adding flash memory on the disk cartridge.

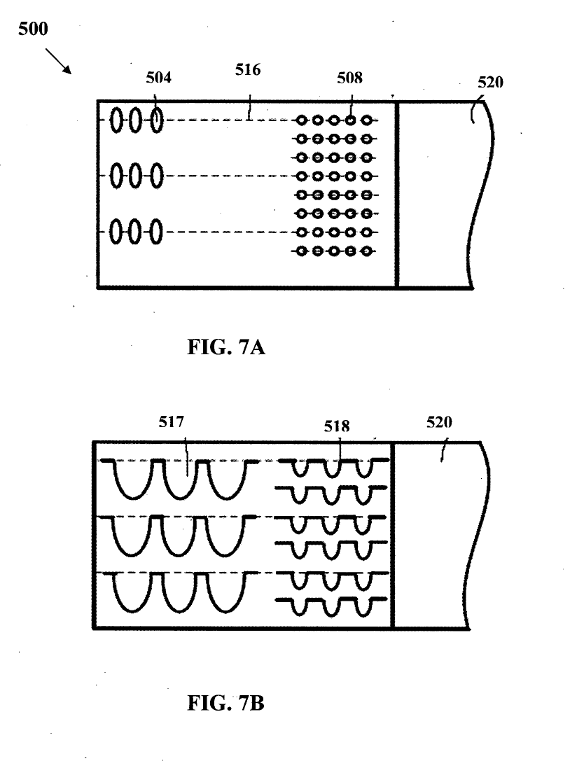

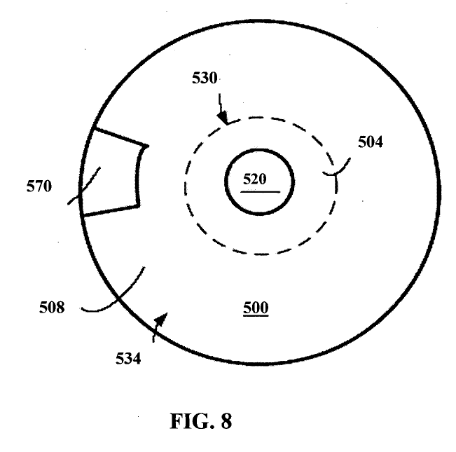

Reference is made to FIGS. 7A and 7B showing respectively a cross section of an information carrier 500 and a read-out signal from such carrier. The data carrier has a non-linear recordable media formed with marks 504 and 508 recorded according to the method of the present invention. It should be understood that such data carrier may be a portion 108 of the above-described hybrid data carrier. The marks are recorded on virtual information layers 516. A pattern of spaced-apart marks 504 corresponds to system data recorded in a way different from a pattern of user data marks 508. As shown in FIG. 7B, a read-out signal 517 from marks 504 has different modulation depth than a read-out signal 518 from marks 508. Recording marks 504 of higher modulation depth may result in slightly larger marks (i.e. the minimally recordable mark may be larger and consequently all marks used would be larger). Marks 508 may be recorded by a first recording event and marks 504 may be recorded by a second recording event that may be of longer duration and/or higher power. When data is retrieved, marks 508 produce a first modulation depth (say 10%) and marks 504 produce a second higher modulation depth (say 20%). A set up capable of recording and retrieving such data is described in U.S. patent publication Ser. No. 11/285,210, assigned to the assignee of the present application, which application is incorporated herein by reference.

The interference between adjacent data positions may become prohibitive as it may become an additional source of errors. In this case, not only the modulation depth between the categorized data blocks may vary, but also collective properties of the recorded data e.g. track pitch, distance between layers, minimal mark size and distance between the marks. In such a case, it is preferable to allocated different regions to the different data block categories. In a specific embodiment that prefers constant linear velocity (CLV) the annular zones towards the rim of the disk 500 (FIG. 7A) are used for system data, allowing more space for recording of each enhanced mark 504.

As exemplified in FIG. 8 showing the data carrier 500 formed with a mounting or clamping hole 520, in another embodiment preferring constant angular velocity (CAV) or Zoned CAV (ZCAV), system data is recorded in a region 530 closer to the center of the disk 600, and user data is recorded in a peripheral region 534. This technique allows lower linear speed for the recording of “system” marks 504 at the same angular velocity (the time to pass a certain distance in the tangential direction at a specific rotation speed increases as the radius decreases). Generally speaking, first and second recording events aimed at recording first and second data pieces, respectively, with different depth of modulation can be implemented with substantially the same recording light power and different event durations. The system data and user data may also be recorded with different FEC codes and redundancies. For example, the system data may be recorded with Solomon-Read ECC at a first error correction redundancy and the user data, such as a video film, may be recorded with BCH or Hammings Error Correction Codes at a second error correction redundancy.

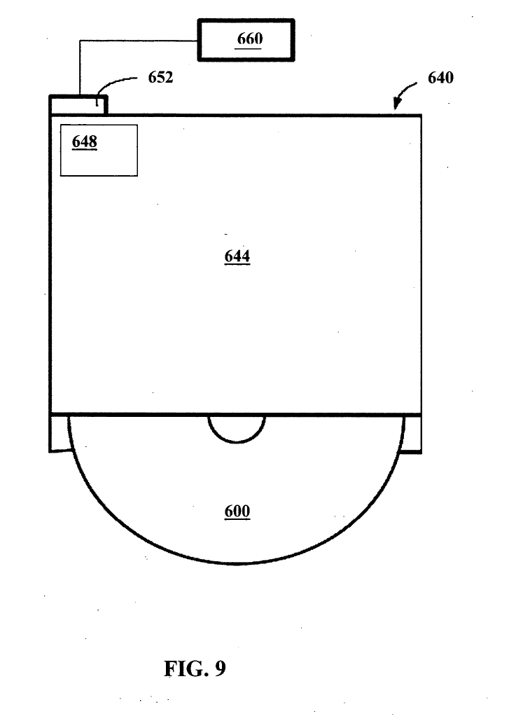

Referring to FIG. 9, there is schematically illustrated a cartridge 640 consisting of a case 644 containing an information carrier 600 (e.g. configured as the above-described data carrier 500) and a flash memory 648. Recording of critical system information is performed simultaneously or in a sequential manner in the data carrier 600 and in flash memory 648. Connector 652 provides a convenient connection of the cartridge and flash memory to a source of power and a controller such as CPU 660. In order to facilitate cartridge to controller connection and maintain the desired disc rotation plane, connector 652 or its mating part may be implemented as a floating connector.

Turning back to FIG. 8, the data carrier 500 may have a special dedicated section 570, which may be of a circular or other form. This section serves for recording therein critical data for back-up purposes.

The above described technique of data recording improves the reliability of reading and decoding of critical data, such as system data, and improves the mode of photochromic storage media utilization. Each of the exemplified methods may be used on its own or a combination of one or more methods further improves the data reading and decoding processes.

Those skilled in the art will readily appreciate that various modifications and changes can be applied to the embodiments of the invention as hereinbefore exemplified without departing from its scope defined in and by the appended claims.

1. An optical data carrier comprising first and second recordable media located in at least one first portion and at least one second portion of the data carrier, respectively, said first and second recordable media differing from each other in a storage capacity and a data recording rate.

2. The data carrier of claim 1, wherein the first and second recordable media differ from each other in the characteristics of optical radiation required for data recording.

3. The data carrier of claim 2, wherein the first and second recordable media differ from each other in the optical radiation power that is required for data recording therein.

4. The data carrier of claim 2, wherein the first and second recordable media differ from each other in a spectrum of the optical radiation required for data recording therein.

5. The data carrier of claim 1, wherein said first recordable media has a higher data recoding rate and lower data storage capacity than the second recordable media.

6. The data carrier of claim 5, wherein said first recordable media is configured as a Blue DVD or HD-DVD media.

7. The data carrier of claim 5, wherein the second recordable media is a non-linear optical media having a fluorescent property variable on occurrence of multi-photon interaction.

8. The data carrier of claim 1, wherein said first and second recordable media are adhesively bonded to each other via an adhesive layer.

9. The data carrier of claim 1, wherein said first and second recordable media are spaced by a retro-reflective layer.

10. The data carrier of claim 3, wherein said first and second recordable media are spaced by a retro-reflective layer preventing the optical radiation used for recording/reading in one of the first and second media, from propagation into the other media.

11. The data carrier of claim 1, wherein said first and second data recordable media are spaced from each other by a reinforcing symmetric carcass which is optically transparent and has higher strength than said second media, which has a fluorescent property variable on occurrence of multi-photon interaction.

12. The data carrier of claim 11, wherein said reinforcing symmetric carcass is made of the same material as said first recordable media.

13. The data carrier of claim 1, wherein the second recordable media comprises recorded marks of different depths of modulation, the marks of higher depth of modulation corresponding to a data pattern of system files, and the marks of lower depth of modulation corresponding to a data pattern of user files.

14. The data carrier of claim 13, wherein the marks corresponding to the system files' data are located in a central region of the data carrier, and the marks corresponding to the user files' data are located in a peripheral region of the data carrier.

15. An optical data carrier comprising a non-linear recordable media having a fluorescent property variable on occurrence of multi-photon interaction, said optical data carrier being configured for recording at least two different data patterns differing from one another in a recording rate and reliability.

16. An optical data carrier comprising a non-linear recordable media having a fluorescent property variable on occurrence of multi-photon interaction, said media comprising recorded marks of different depths of modulation, the marks of higher depth of modulation corresponding to a data pattern of system files, and the marks of lower depth of modulation corresponding to a data pattern of user files.

17. A method for use in data recording on a hybrid optical data carrier configured according to claim 1, the method comprising recording data in the first recordable media with a relatively high recording rate; and transferring at least a part of said data recorded in the first recordable media into the second recordable media.

18. A method for use in data recording on a hybrid optical data carrier configured according to claim 1, the method comprising separately recording first and second data pieces in the first and second recordable media, respectively, with relatively high and low data recording rates; and transferring at least a part of said first data piece from the first recordable media into the second recordable media.

19. A method for use in data recording in the non-linear recordable media of the data carrier of claim 13, the method comprising performing first and second recording events for recording first and second data pieces, respectively, using substantially the same recording light power and different event durations.

20. A drive system for use in recording/reading data in a hybrid optical data carrier configured according to claim 1, the system comprising: a first optical unit adapted for recording and reading data in the first recordable media; a second optical unit adapted for recording and reading data in the second recordable media; and a control unit including a first control utility adapted for analyzing and distributing data to be recorded between the first and second recordable media portions, and a second control utility adapted for transferring recorded data between the first and second recordable media portions.
